(19) United States
(12) Patent Application Publication
(10) Pub. No.: US 2026/0081772 A1
(43) Pub. Date: Mar. 19, 2026

(54) Systems and Methods for Memory-Native Identity and Authentication

(71) Applicant: Nicholas Clark, Thetford Center, VT (US)

(72) Inventor: Nicholas Clark, Thetford Center, VT (US)

(21) Appl. No.: 19/388,580

(22) Filed: Nov. 13, 2025

Related U.S. Application Data
(60) Provisional application No. 63/726,519, filed on Nov. 30, 2024.
(60) Provisional application No. 63/787,082, filed on Apr. 11, 2025.
(60) Provisional application No. 63/789,967, filed on Apr. 16, 2025.
(60) Provisional application No. 63/800,515, filed on May 6, 2025.

(51) Int. Cl. H04L 9/08

(52) U.S. Cl. CPC H04L 9/088

(57) ABSTRACT

Memory-native authentication in distributed environments is provided in which agents and devices form dynamic identities as successors along a trust slope using locally retained unpredictability and policy context, without persistent private keys. A Dynamic Agent Hash (DAH) and a Dynamic Device Hash (DDH) are computed from a prior state and either a hardware-anchor with volatile salt or a stability-tuned local state vector processed by a strong extractor, or a hybrid thereof. Messages employ two-stage validation: a header DAH for transport continuity and an embedded sender DAH inside the encrypted payload, where the symmetric key is derived from the recipient's current DAH/DDH. Agent mutations are entangled to host DDHs and recorded in an append-only lineage with periodic anchors, enabling delayed and sparse verification, predictive drift detection, entropy-anchor rotation, and quorum-based recovery after memory loss. An isolated fallback identifier supports legacy PKI interoperability.

### RELATED APPLICATION DATA

This application claims the benefit of priority of U.S. Provisional Patent Application Ser. No. 63/726,519, filed on Nov. 30, 2024, titled “Adaptive Network Framework (ANF) for Modular, Dynamic, and Decentralized systems”, U.S. Provisional Application Ser. No. 63/787,082, filed on Apr. 11, 2025, titled “AQ (Adaptive Query): A Programming Language and Cognitive Execution Layer for Distributed, Stateful A1”, U.S. Provisional Application Ser. No. 63/789,967, filed on Apr. 16, 2025, titled “Cross-Domain Applications of the Adaptive Query Framework”, U.S. Provisional Patent Application Ser. No. 63/800,515, filed on May 6, 2025, titled “Cognition-Native Semantic Execution Platform for Distributed, Stateful, and Ethically-Constrained Agent Systems”, each of which is incorporated by reference herein in its entirety.

### REFERENCE TO COMPUTER PROGRAM LISTING APPENDIX

A Computer Program Listing is submitted concurrently with the specification as a TXT formatted file, with a file name of “20596-005USU1-Computer-Program-Listing-Appendix.txt”, a creation date of Nov. 13, 2025, and a size of 47 kilobytes. The Computer Program Listing filed is part of the specification and is incorporated in its entirety by reference.

### FIELD

The present disclosure generally relates to cryptographic systems and methods for determining digital identify and authentication, and more specifically to systems and methods for memory-native identity and authentication without keypairs.

### BACKGROUND

Conventional digital identity and authentication systems rely on persistent public-private keypairs and signature-based validation mechanisms. These systems expose users and devices to various vulnerabilities, including key compromise, metadata correlation, certificate revocation failure, and susceptibility to quantum cryptographic attacks. Public key infrastructure (PKI) typically requires centralized trust anchors, global registries, and persistent key material, making it unsuitable for decentralized, memory-constrained, or privacy-sensitive environments. Moreover, in ephemeral or cognition-native systems-such as distributed AI agents or stateless substrates—the requirement to maintain static credentials is impractical or infeasible. Accordingly, there is a need for systems and methods that address these shortcomings.

### SUMMARY OF THE DISCLOSURE

A computer-implemented method for memory-native two-stage authentication includes generating, by a sender agent, a dynamic agent hash (DAH_t) as a successor of a prior trusted dynamic agent hash (DAH_{t−1}) generated by the sender agent, wherein the DAH_t is generated under an update rule that incorporates at least one unpredictability contribution and a volatile salt, deriving, by the sender agent, a symmetric encryption key from a current dynamic identity of a recipient selected from a recipient dynamic agent hash (DAH_R) or a recipient dynamic device hash (DDH_R), encrypting a payload with the symmetric encryption key and embedding within the encrypted payload an embedded sender dynamic agent hash (DAH_S) computed contemporaneously with the DAH_t, constructing, by the sender agent, a message comprising a transport header and the encrypted payload, and placing the DAH_t in the transport header and the DAH_S within the encrypted payload, wherein the message does not include the symmetric encryption key, transmitting, by the sender agent, the message to the recipient, receiving, by the recipient, the transmitted message and reconstructing, from a locally retained trust-slope state for the sender agent that includes at least the DAH_{t−1} most recently validated and previously accepted by the recipient, an expected successor candidate for time t under the update rule and within a recipient-defined set of policy-bounded continuity parameters, validating, by the recipient, the DAH_t against an expected successor candidate, deriving, by the recipient, a recipient symmetric encryption key from a corresponding one of DAH_R or DDH_R and decrypting the payload, extracting, by the recipient, the DAH_S from the decrypted payload and validating the DAH_S against a reconstructed trust slope for the sender agent obtained by advancing the locally retained trust-slope state under the update rule and within the recipient-defined set of policy-bounded continuity parameters, and accepting, by the recipient, the message only upon successful validation of both the DAH_t and the DAH_S.

A system for agent mutation entanglement is provided that includes a host device configured to compute a dynamic device hash (DDH_t) as a successor of a prior dynamic device hash (DDH_p) under an update rule that incorporates at least one unpredictability contribution and a volatile salt, a semantic agent configured to execute on the host device and to compute a successor dynamic agent hash (DAH_s) from a prior dynamic agent hash (DAH_p) and a host mutation token derived from the DDH_t and a mutation class associated with the host device, an entanglement module configured to emit a signed entanglement trace that records DAH_p, DDH_t, the host mutation token, DAH_p, and mutation metadata, and a validator configured to accept DAH_s only if the entanglement trace opens to DDH_t under policy and DAH_s is a valid successor of DAH_p.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 illustrates components and steps of a lifecycle of a Dynamic Agent Hash (DAH) or Dynamic Device Hash (DDH) within the Dynamic Signature Mesh (DSM) in accordance with an embodiment of the present disclosure;

FIG. 2 illustrates a sparse slope reconstruction process from a checkpoint using bounded proofs and periodic anchors in accordance with an embodiment of the present disclosure;

FIG. 2A illustrates a stepwise replay process of FIG. 2 in more detail;

FIG. 3 illustrates components for a process for fallback compatibility with legacy, signature-based systems in accordance with an embodiment of the present disclosure;

FIG. 4 illustrates components of a DSM-secured message and steps for processing the DSM-secured message in accordance with an embodiment of the present disclosure;

FIG. 5 shows a process for detection and rejection of spoofed or replayed identity claims in accordance with an embodiment of the present disclosure;

FIG. 6 illustrates components and steps for predictive validation of agent and device identity in accordance with an embodiment of the present disclosure;

FIG. 7 illustrates components and steps for agent-to-substrate slope entanglement in accordance with an embodiment of the present disclosure;

FIGS. 8A and 8B illustrate an example of an append-only mutation lineage log for an agent in accordance with an embodiment of the present disclosure;

FIG. 9 illustrates components and steps for quorum-based recovery after memory loss in accordance with an embodiment of the present disclosure;

FIG. 10 illustrates components and steps for rotation of an entropy anchor and adaptive reinitialization of a trust slope in accordance with an embodiment of the present disclosure;

FIG. 11 shows components and steps for delayed slope validation under high-latency or intermittent connectivity conditions in accordance with an embodiment of the present disclosure; and

FIG. 12 provides an overview of components and steps for determining cumulative slope entanglement across multiple substrate nodes during agent migration in accordance with an embodiment of the present disclosure.

### DETAILED DESCRIPTION

### 1. Overview

An authentication architecture is needed that operates securely without persistent keys or external verification authorities, and instead derives identity from locally retained, time-sensitive, and context-aware behavioral information. A memory-native identity substrate is provided in which a device or agent expresses identity as a trust slope—that is, the cumulatively validated sequence of Dynamic Agent Hashes (DAHs) or Dynamic Device Hashes (DDHs) formed by successive, verifiable identity mutations-rather than a static credential. Trust-slope continuity denotes that a presented successor is a valid descendant of a previously trusted state under policy-bounded checks. Each identity step is computed from the immediately prior step and a source of non-exported unpredictability, enabling receivers to evaluate continuity and provenance locally, without reliance on centralized authorities, long-lived keypairs, or synchronized registries.

In one embodiment, a static hardware anchor is combined with a volatile, non-repeating salt to derive a per-epoch contribution. In another embodiment, a locally observed state is collected into a local state vector and transformed by a strong extractor to yield a bounded pseudorandom token; the token is then combined with a volatile salt. Either of these embodiments alone, or a hybrid that incorporates both in the same step, produces a successor identity value bound to time, context, and prior state. In this way, constrained devices can be accommodated that expose a hardware identifier as well as richer platforms that can derive robust local state vectors.

The trust slope is append-only and verifiable: a receiver stores any previously trusted step and evaluates a presented successor against policy-defined continuity criteria. Because each step binds to the prior step and to non-exported unpredictability, an attacker lacking the device's local state (or volatile salt) cannot feasibly synthesize valid successors. The continuity policy is tunable to favor stability within a role or operating context while remaining sensitive to genuine context changes. This may be achieved by constructing the local state vector with stability-preserving projections and by verifying bounded drift with error-tolerant sketches.

Messages are constructed so that identity is bound at both transport and semantic layers. A sender places the current dynamic hash in the message header for fast, stateless screening at the receiver, and also embeds the same value inside the protected payload to bind semantics to transport. In certain embodiments, payload confidentiality and integrity are derived from receiver-local identity material (e.g., via a key derivation based on the receiver's current dynamic hash), allowing two-stage validation that rejects malformed traffic before decryption and prevents man-in-the-middle substitution after decryption.

In addition, an append-only lineage mechanism is provided in which each identity step is committed into a compact chain of commitments with periodic anchors. This permits sparse storage at senders and receivers while enabling delayed or offline reconstruction of intervening steps. Where recent anchors are missing or devices are intermittently connected, receivers request short proofs or checkpoints and verify the recomputed path against stored anchors, preserving verifiability in delay-tolerant and edge environments.

To maintain long-term health of the identity process, the system supports reseeding and anchor rotation policies that detect staleness or environmental drift and initiate controlled re-anchoring without breaking verifiability; forward links are recorded so downstream verifiers can bridge old and new anchors under policy. In addition, a quorum-based recovery path allows a device or agent to rejoin the trust graph after state loss by aggregating attestations from previously trusted peers, with the recovery token recorded into lineage for downstream audit.

### 2. Identity Generation and Trust Slope

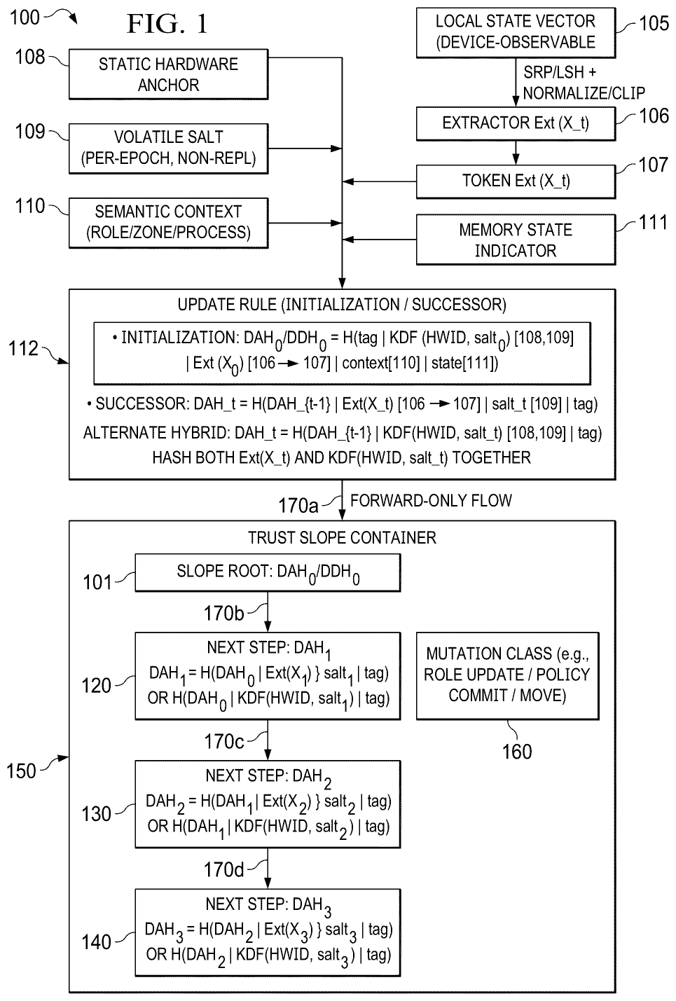

FIG. 1 provides a schematic overview of components and a process 100 for the generation and evolution of a memory-native identity for a device or agent as a verifiable trust slope. At initialization, a slope root 101 is established by computing a dynamic hash from one of two exemplary ways. In the first, a static hardware anchor 108 (e.g., TPM, TEE, SoC identifier) is combined with a volatile salt 109 to yield an unpredictable seed. In a second, a locally observed state is collected into a local state vector 105, processed by an extractor 106 to produce a bounded pseudorandom token 107, and combined with a volatile salt 109. A semantic context vector 110 and a memory state indicator 111 may be incorporated to bind role, zone, or process mix to the initial identity. The resulting dynamic device or agent hash at epoch t=0 establishes DAH₀/DDH₀ at the slope root 101.

The initial identity is advanced by an update rule 112 that concatenates the prior hash with a fresh entropy input and a domain-separating tag to yield the next step on the slope. In one example, the update is computed as DAHₜ=H(DAHₜ₋₁∥Ext(Xₜ)∥saltₜ∥tag), where Xₜ is derived from the local state vector 105 and Ext(⋅) denotes the extractor 106. Alternatively, the update is computed as DAHₜ=H(DAHₜ₋₁∥KDF(HWID, saltₜ)∥tag) using the hardware anchor 108 and volatile salt 109. These may be combined by hashing both inputs in a single step to increase robustness. Application of the update yields successive identities DAH₁ 120, DAH₂ 130, and DAH₃ 140 along a verifiable trust slope 150, with arrows 170a-170d indicating the forward-only process flow rather than hardware connections.

In the local-state embodiment, the local state vector 105 consists of device-observable signals sampled within an epoch, including one or more of monotonic counters, high-resolution timing deltas, CPU performance counters, scheduler jitter statistics, I/O inter-arrival micro-jitter, optional sensor noise, rolling process histograms, and short-horizon sketches of recent dynamic hashes. The feature map that produces Xₜ from the local state vector applies normalization and clipping to bounded ranges, projects to a fixed dimension via signed random projections with a public seed, optionally appends a discrete context code derived from the semantic context vector 110, and applies a locality-sensitive binarization so that small fluctuations in the local state yield stable Xₜ while genuine role or zone changes flip a controlled subset of bits. The extractor 106 (e.g., a SHA-3/512-based KDF) maps Xₜ to the token 107 with collision and preimage resistance suitable for use in the update rule described above.

To align with the example code in the Computer Program Listing, the following steps may be performed within each epoch: compute Xₜ from the local state vector 105 using the signed-projection and locality-sensitive mapping just described; compute the token 107 as Ext(Xₜ); compute DAHₜ by hashing DAHₜ₋₁ with the token 107, the volatile salt 109, and a domain-separating tag; and record a mutation class 160 identifying the semantic reason for the step (e.g., role update, delegation, policy commit). Each step appends a trace entry to the memory state 111, thereby enabling downstream verification that DAHₜ is a valid successor to DAHₜ₋₁ on the trust slope 150.

The hardware-anchor embodiment proceeds analogously but replaces the token 107 with a keyed derivation from the hardware anchor 108 and the volatile salt 109. The volatile salt 109 is non-repeating at the device and epoch level, ensuring unpredictability even if the hardware anchor 108 is constant. In the combined embodiment, both the token 107 and a key derivation from the hardware anchor 108 are included in the same update to produce DAHₜ, thereby retaining compatibility with constrained devices while benefiting from locally derived state on richer platforms.

The trust slope 150 thereby encodes continuity of identity over time as a sequence of dynamic hashes, each step bound to either the hardware anchor 108 with the volatile salt 109, the local state vector 105 with the extractor 106, or both. Mutation classes 160 are recorded for each step to preserve semantic provenance, and arrows 170a-170d indicate that the process is append-only. The construction enables verifiable identity in disconnected or asynchronous networks, because validation of the successor relationship between DAHₜ and DAHₜ₋₁ does not require access to external authorities, keys, or registries.

### 3. Stateless Symmetric Encryption

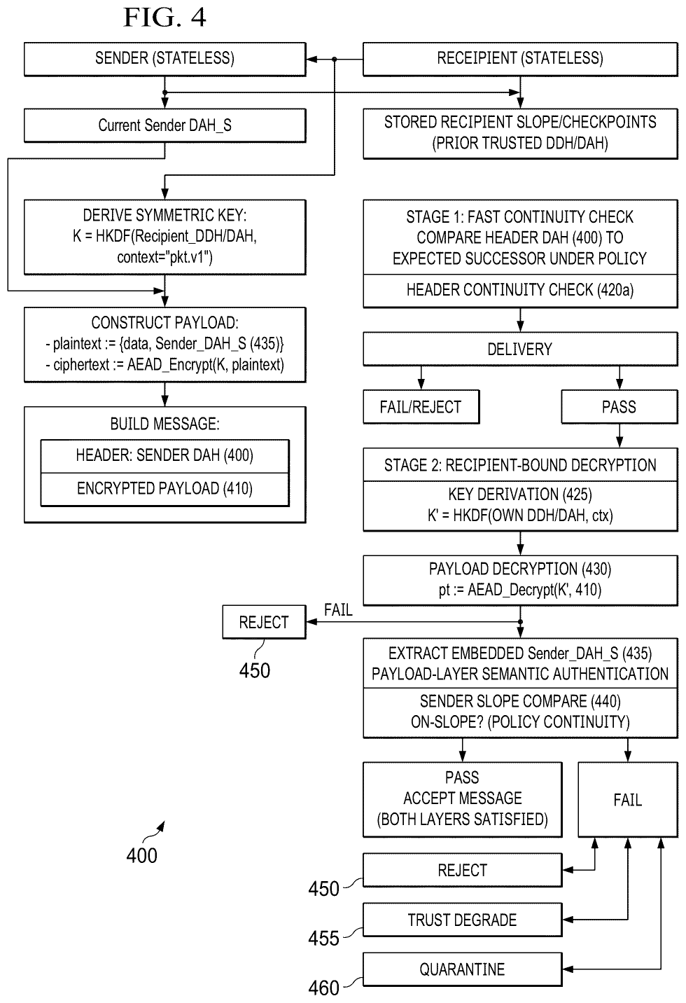

FIG. 4 illustrates an exemplary process 400 in which a sender 401 derives a symmetric encryption key from a recipient's 407 current DDH or DAH by applying a key-derivation function to the recipient identity and a domain-separating context 402. The sender then performs authenticated encryption over the payload, embedding an additional copy of the sender's current DAH inside the ciphertext for payload-layer verification 403. The resulting message 404 contains the header DAH 405 and the encrypted payload 406. When the local-state embodiment is used for identity, the recipient's DDH or DAH that seeds key derivation is produced from a local state vector and extractor as described previously; when the hardware-anchor embodiment is used, the recipient identity is produced from a hardware anchor combined with a volatile salt; when a hybrid technique is used, both sources contribute to the same identity value for key derivation.

Upon receipt 409, the node performs a two-stage validation. First, the node evaluates the header DAH 410 against its last trusted successor 411 by applying a fast continuity check 412 that confirms the presented header is an on-slope successor relative to stored state; if continuity cannot be established from immediately available checkpoints, the node may defer final acceptance 413 until a bounded proof or checkpoint is obtained as described in Section 4. If the check passes 414, the node derives a decryption key from its own current DDH or DAH using a key-derivation step 420 and attempts decryption 430 of the payload 406. Successful decryption demonstrates that the payload was encrypted for the correct memory-resolved identity state of the recipient at the time of transmission.

Following decryption, the node extracts the embedded sender DAH 440 from the plaintext and compares it to the expected successor on the sender's trust slope using the receiver's stored reference and policy-defined continuity bounds. This payload-layer comparison provides semantic authentication independent of the transport header, ensuring that both routing-level and content-level integrity are satisfied before the message is accepted 450. If either stage fails 460, the node records a rejection 470, optionally degrades the sender's trust score 480 under local policy, and may place the message or sender into quarantine 490 for subsequent review.

In deployments where the sender 401 lacks the recipient's 407 current DAH or DDH, the sender derives the symmetric key from the most recent trusted recipient anchor or epoch and transmits a first attempt under a bounded rekey failure rate. Upon decryption failure, the sender initiates a fallback comprising either (i) a short challenge-response rekey handshake scoped to the recipient's current epoch or (ii) a checkpoint request that yields a bounded proof window sufficient to advance to the current recipient identity. The two-stage authentication thereafter proceeds using the updated recipient identity without reliance on external certificate authorities or persistent key exchange.

The foregoing allows for stateless operation. The sender and recipient maintain no long-lived session material; all keys are derived transiently from DAH/DDH values that themselves are produced by the identity update rules. In embodiments where the local-state vector produces the identity token via an extractor, stability-tuned projections and error-tolerant sketches ensure that small fluctuations in local measurements do not cause spurious decryption failures, while genuine role or context changes intentionally alter the recipient identity and force rekeying. In embodiments where the hardware anchor and volatile salt produce identity, freshness is preserved by the per-epoch salt, and in hybrid embodiments both inputs are hashed into the same identity value to improve robustness across devices and environments.

An implementable embodiment aligned with the attached reference code performs, at the sender, a key derivation from the recipient's current identity using a domain-specific context string and applies authenticated encryption to the payload while embedding the sender's current DAH inside the ciphertext; at the receiver, a corresponding derivation from its current identity reproduces the symmetric key to decrypt the payload, after which the embedded sender DAH is verified against the stored sender slope. In all cases, header validation, recipient-bound key derivation, payload decryption, embedded DAH comparison, and failure outcomes are process flows rather than hardware links and are driven entirely by the memory-native identity substrate and local policy.

### 4. Trust Slope Validation and Resistance to Spoofing and Replay

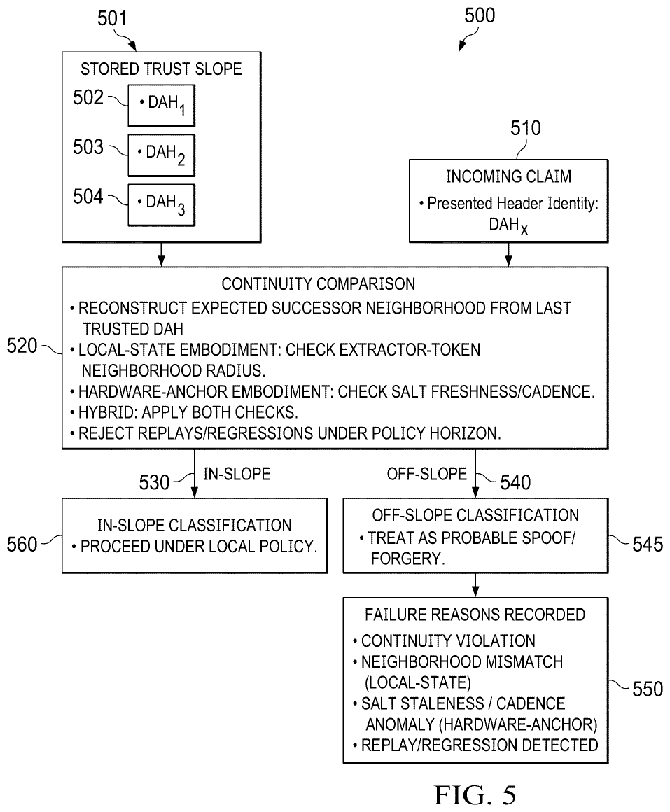

FIG. 5 illustrates a process 500 for the validation of an incoming identity claim against a previously trusted trust slope to resist spoofing, forgery, and replay. A stored trust slope 501 comprises successive dynamic identities DAH₁ 502, DAH₂ 503, and DAH₃ 504 derived under the update rules disclosed herein. Upon receipt of a message or agent presentation bearing a claimed identity DAH_x 510 in its transport header, the executing node evaluates whether the claim is an on-slope successor relative to its last trusted state under policy-defined continuity bounds.

In one embodiment, the node performs a fast continuity comparison 520 by reconstructing the expected successor neighborhood from the most recent trusted value (e.g., DAH₃ 503) and verifying that the presented DAH_x 510 is a valid successor. When the local-state embodiment is used, continuity bounds are enforced using a stability-tuned acceptance radius over extractor outputs computed from local state vectors; when the hardware-anchor embodiment is used, bounds are enforced using per-epoch salt freshness and cadence constraints; when a hybrid embodiment is used, both checks are applied. If the claim satisfies continuity, the node classifies it as in-slope 530 and proceeds 560; otherwise, the claim is classified off-slope 540 and treated as a probable spoof or forgery.

In embodiments employing stability-tuned local state vectors, the node may optionally validate a short distance sketch accompanying the claim to confirm that the extractor output corresponding to DAH_x 510 would lie within a policy-defined neighborhood, without revealing the underlying local state. In hardware-anchor embodiments, the node verifies that the volatile salt used to derive the presented successor is fresh relative to prior observations and expected cadence. Either path preserves deterministic rejection of off-manifold or stale claims without reliance on external registries or long-lived keys.

Replay resistance is achieved by binding acceptance to monotonic progression along the trust slope and by enforcing non-reuse of previously accepted successors within a policy horizon. If the presented DAH_x 510 equals a previously accepted value for the same sender and context, or if it regresses behind the node's last trusted state, the node rejects the presentation as a replay or regression. Policy may optionally require that accepted successors advance a local epoch counter or satisfy a minimum inter-step interval to mitigate rapid replays.

Failure outcomes 545 are recorded with explicit reasons 550, which may include continuity violation, neighborhood mismatch, salt staleness, cadence anomaly, or replay detection. Based on local policy, the node may immediately reject the claim, degrade the sender's trust score, or place the sender into quarantine pending further evidence. When continuity is established, the node accepts the claim, updates its stored reference, and appends a validation trace to its local memory.

The foregoing validation operates identically across both unpredictability sources. In the hardware-anchor embodiment, successors are verified using per-epoch salted derivations of the static anchor; in the local-state embodiment, successors are verified using extractor tokens derived from stability-tuned local state vectors; in the hybrid embodiment, both sources are incorporated into each successor, and either's anomaly is sufficient to fail continuity. Arrows in FIG. 5 indicate process flows rather than hardware connections, and acceptance or rejection decisions (530, 540) are driven entirely by locally available trust-slope lineage and policy without external authorities.

### 5. Agent Mutation and Substrate Entanglement Mechanisms

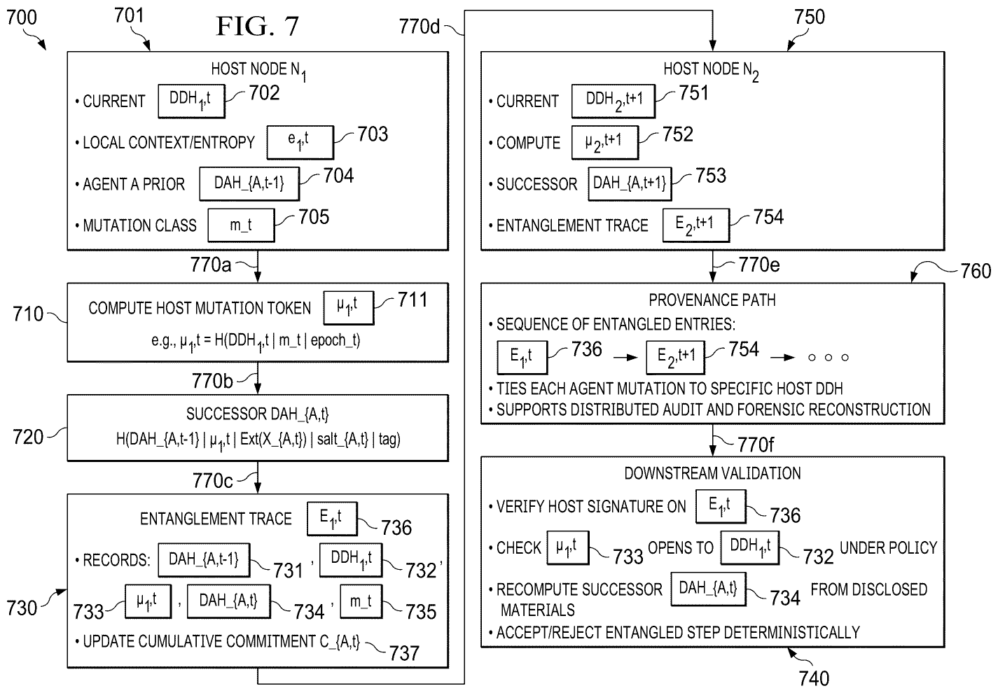

As used herein, an “agent” refers to a cryptographically signed, memory-bearing data object that acts as a protocol operand within the disclosed substrate and includes a unique identifier, a payload, a memory field, a transport header, and a cryptographic signature, and participates in trust-slope formation and validation as described herein. A “semantic agent” is a specialized agent that additionally comprises an intent field and cognition-compatible structure enabling policy-aware mutation, delegation, and context-sensitive execution. FIG. 7 illustrates a process 700 for secure agent mutation with substrate entanglement, in which each agent-side identity transition

A host node Ni 701 maintains a current Dynamic Device Hash (DDH₁,t) 702 computed under the update rules of Section 2. In one embodiment, DDH₁,t 702 is derived from a static hardware anchor combined with a volatile salt; in another embodiment, it is derived from a local state vector processed by a strong extractor; in a hybrid embodiment, both contributions are included in the same update. The host also maintains local context and entropy inputs e₁,t 703 used to parameterize mutation policy for the current epoch. An incoming semantic agent A with prior Dynamic Agent Hash DAH_{A,t−1} 704 is admitted to the execution context of Ni 701.

When agent A initiates a mutation (e.g., role change, delegation, policy commit, or semantic state transition), the host computes a mutation class indicator m_t 705 and derives a host mutation token μ₁,t 710/711 bound to the then-current DDH₁,t 702. In one embodiment, μ₁,t 711 is computed as H(DDH₁,t∥m_t∥epoch_t); in another embodiment, μ₁,t 711 is a commitment that additionally binds stability-tuned features of e₁,t 703. The agent's successor identity DAH_{A,t}720 is then computed as DAH_{A,t}=H(DAH_{A,t−1}∥μ₁,t∥Ext(X_{A,t})∥ salt {A,t}∥ tag), where Ext(X_{A,t}) is the agent-side extractor output derived from the agent's memory field and semantic context at time t, salt {A,t} is a volatile agent salt, and tag is a domain separator. In embodiments where the agent does not maintain an agent-side extractor, the term Ext(X_{A,t}) is omitted and μ₁,t 711 remains the sole mutation driver together with DAH_{A,t−1} 704 and salt_{A,t}.

The host records an entanglement trace entry E₁,t 730 that includes (i) DAH_{A,t−1} 731, (ii) DDH₁,t 732, (iii) μ₁,t 733, (iv) the resulting successor DAH_{A,t} 734, and (v) the mutation class m_t 735, and signs the entry with the host's private key. The agent appends E₁,t 736 into its memory field and updates its cumulative commitment C_{A,t} 737=H(C_{A,t−1}∥E₁,t), providing forward-secure tamper evidence. Arrows 770a-770c indicate process flows rather than hardware connections.

Validation of the entangled mutation is local and deterministic. A downstream verifier replays the agent's mutation at step 740 by checking that DAH_{A,t}734 is a valid successor of DAH_{A,t−1} 731 under the disclosed μ₁,t 733 and salt {A,t}, verifies the host signature on E₁,t 736, and confirms that μ₁,t 733 is consistent with the referenced DDH₁,t 721 and policy m_t 705. Because DDH₁,t 702 is itself produced under Section 2's update rules (hardware-anchor plus salt; local-state plus extractor; or hybrid), an attacker lacking the host's device identity inputs cannot synthesize μ₁,t 733 or forge E₁,t 736 to produce an acceptable DAH_{A,t}741.

Agents that traverse multiple substrates accumulate a verifiable trail of entangled mutations. As shown, when agent A later executes on node N₂ 750, the host's current DDH₂,t+1 751 yields a new host mutation token μ₂,t+1 752, and the agent advances to DAH_{A,t+1} 753 with a corresponding entanglement trace E₂,t+1 754. A sequence of such entries forms a provenance path 760 tying each agent-side identity transition to the specific host device on which it occurred, enabling distributed audit and forensic reconstruction without external registries or synchronized ledgers.

The entanglement mechanism is agnostic to the unpredictability source used by the host. In the hardware-anchor embodiment, μ_{*,t}733/752 incorporates freshness via per-epoch salts bound to a static anchor; in the local-state embodiment, μ_{*,t}733/752 includes extractor outputs over stability-tuned local state; in a hybrid embodiment, both are concatenated within _{*,t}. In all cases, the verifying node fails closed if (i) the host signature on E_{*,t} is invalid, (ii) _{*,t} does not open to a host DDH consistent with policy, or (iii) DAH_{A,t} is not a valid successor under the disclosed materials.

Entanglement traces may be authenticated by either (a) a host digital signature or (b) a message authentication code (MAC) keyed by a value derived from the contemporaneous DDH_t via a domain-separated key derivation function. In the MAC embodiment, keys are ephemeral and locally scoped to the host epoch and are never registered or reused across epochs, thereby preserving the “no persistent keypair” property while enabling verifiable entanglement.

In embodiments employing signatures, the host may mint an ephemeral signing keypair per epoch and destroy the private key upon rotation; the entanglement trace includes an epoch identifier that opens to the host's DDH_t under policy so that acceptance does not depend on long-lived signing keys.

By coupling agent mutation to host device identity, slope entanglement prevents off-substrate evolution and detects out-of-band tampering. A purported successor lacking a coherent E_{*,t}736/754, or referencing a host DDH that cannot be validated under local policy, is rejected at step 740, and the presentation may trigger trust degradation or quarantine per deployment policy. FIG. 7 thus demonstrates that each agent mutation step is verifiably anchored to a trusted device identity (702, 751), with process flows 770d-770f indicating process steps rather than hardware links.

### 6. Construction and Validation of Append-Only Mutation Lineage Logs

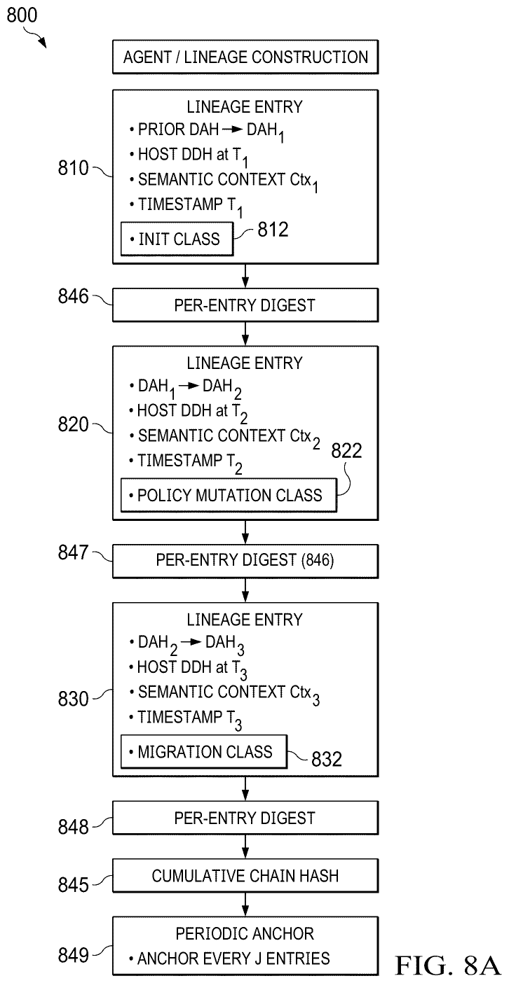

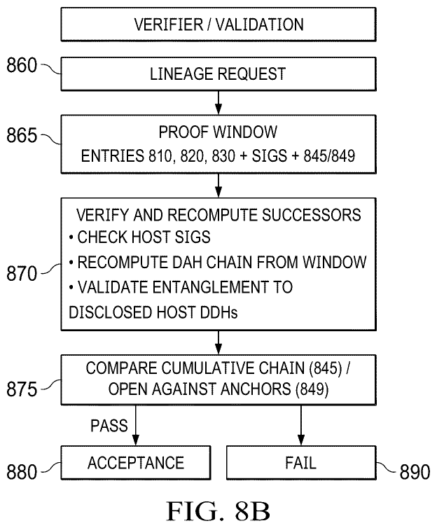

FIGS. 8A and 8B illustrate a process 800 and components for implementing an append-only mutation lineage that records the evolutionary history of a semantic agent's identity as a tamper-evident sequence of entries. In FIG. 8A, a first lineage entry 810 captures an initial successor DAH₁ together with the host device identity DDH₁, a semantic context Ctx₁, and a timestamp T₁; the entry is classified with an initialization class indicator 812 and signed by the executing host. A subsequent entry 820 advances the agent identity to DAH₂ under a policy-driven mutation class 822, while a further entry 830 advances to DAH₃ under a migration class 832; each entry is produced by the successor rule that binds the prior agent identity, a host mutation token derived from the host DDH at the time of execution, and a freshness input comprising either a hardware-anchor-derived contribution, a local-state-vector extractor output, or both in a hybrid embodiment, as previously described with respect to agent-substrate entanglement.

For each entry i, the agent computes the successor DAH_{i} as H(DAH_{i−1}II p_{host,i}∥ Ext(X_{A,i})∥salt_{A,i}∥ tag) when the local-state embodiment is used, or as H(DAH_{i−1}∥ _{host,i}∥ KDF(HWID, salt {A,i})∥tag) when the hardware-anchor embodiment is used; in a hybrid configuration the extractor output and the hardware-anchor contribution are concatenated prior to hashing. Each lineage entry includes the prior DAH, the resulting DAH, the host DDH in effect at execution, the mutation class, and a timestamp, and the executing host appends a host-signed entanglement trace that binds_{host,i} to the disclosed DDH for the epoch. Arrows in FIG. 8A indicate process flows rather than hardware connections.

Integrity of the lineage is preserved by a cumulative chain hash 845 that is updated at each entry; in one embodiment, the per-entry digest 846-848 is computed over the structured contents of the entry and then folded into the cumulative hash as C_{i}=H(C_{i−1}II), producing a forward-secure ledger in which any omission, reordering, or modification of entries is detected by divergence of the terminal cumulative value. In a size-bounded embodiment, periodic anchors 849 are produced every J entries by hashing the then-current cumulative value with the prior anchor, enabling compact proofs over long histories without retaining all intermediate entries.

Validation proceeds by bounded replay from a stored reference and the provided window of entries, as shown for example in FIG. 8B. A verifier issues a lineage request 860 and receives a proof window 865 comprising the referenced entries (e.g., 810, 820, 830), the corresponding host signatures, and either a terminal cumulative hash 845 or a set of periodic anchors 849 sufficient to open the window against a previously trusted anchor. The verifier 870 checks that each host signature is valid for the disclosed host identity, recomputes each successor DAH using the disclosed materials, confirms that the entanglement token for each step is consistent with the referenced host DDH and mutation class, and folds each per-entry digest (e.g., 846-848) to reach the terminal cumulative hash 845; acceptance 880 follows when the recomputed cumulative 875 value opens to the trusted anchor and all per-step checks succeed.

Replay resistance and non-transferability are enforced during validation by rejecting any entry whose successor DAH is a regression relative to the verifier's stored reference or whose freshness input is stale or inconsistent with policy cadence; entries that reproduce previously accepted successors for the same sender and context within a replay horizon are rejected as replays. Tamper attempts, including omission or reordering, are detected when the recomputed cumulative chain fails to match the provided 845 or cannot be opened against the periodic anchors 849, producing a tamper finding 890 recorded in local memory under policy.

The lineage is agnostic to unpredictability source and supports domain-specific governance. When the hardware-anchor embodiment is used exclusively, the freshness input within each entry derives from a volatile salt keyed to a static hardware identifier; when the local-state embodiment is used exclusively, it derives from an extractor over a stability-tuned local state vector; when hybridized, both inputs are included to strengthen continuity across heterogeneous devices. Entries may include policy-relevant metadata such as mutation classes 812, 822, 832 and execution zone identifiers, enabling different trust domains to enforce local acceptance while preserving cryptographic interoperability through the cumulative chain 845 and anchors 849.

By recording, signing, and chaining each identity transition, the append-only mutation lineage of FIGS. 8A and 8B provides verifiable provenance for semantic agents operating across decentralized substrates, enables incremental validation from recent anchors or comprehensive reconstruction from a prior trusted point, and detects spoofing, forgery, and replay attempts using only locally available materials and bounded proofs, without reliance on external authorities, persistent key registries, or synchronized ledgers.

### 7. Cumulative Slope Validation Across Distributed Substrates

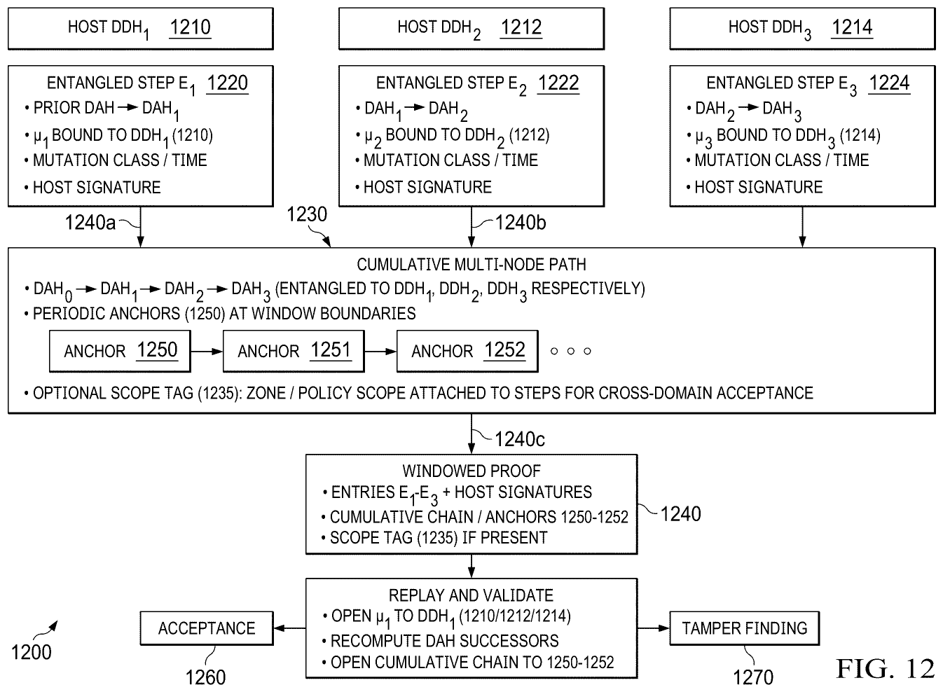

FIG. 12 illustrates a process 1200 for cumulative validation of an agent's identity slope as the agent migrates across multiple substrate nodes, with each mutation step entangled to the executing host's device identity. A semantic agent A enters a first host node Ni and advances from a prior agent identity to a successor recorded as an entangled step E₁ 1220, bound to the host's current Dynamic Device Hash DDH₁ 1210. The agent subsequently executes on nodes N₂ and N₃, producing further entangled steps E₂ 1222 bound to DDH₂ 1212 and E₃ 1224 bound to DDH₃ 1214, respectively. The sequence of entangled steps E₁-E₃ forms a tamper-evident multi-node path 1230 capturing both identity evolution and execution provenance across substrates; arrows 1240a-1240c indicate process flows rather than hardware connections.

In one embodiment, each entangled step Eᵢ 1220/1222/1224 is constructed according to the mutation mechanism described with respect to FIG. 7, wherein a host mutation token i is derived from the executing host's current DDHᵢ (e.g., 1210, 1212, 1214) and a mutation class, and the agent's successor identity is computed as H(DAH_{i−1} ∥freshness_i∥tag). The freshness input may be produced from a static hardware anchor combined with a volatile salt, from a local state vector processed by a strong extractor, or from a hybrid of both sources within the same step; all three embodiments are enabled and interoperable within the same cumulative path 1230.

Each entangled step is recorded into the agent's append-only lineage as a signed entry that includes the prior DAH, the resulting DAH, the executing host's DDHᵢ (e.g., 1210, 1212, 1214) in effect at execution, the mutation class, and a timestamp. Per-entry digests are folded into a cumulative chain value and, in size-bounded embodiments, periodic anchors 1250-1252 are emitted at selected intervals to permit compact proofs across long multi-node traversals. Cross-domain context-such as zone or policy scope—is optionally recorded as a scope tag 1235 to support federation without centralized oversight.

A verifier reconstructs the cumulative slope by requesting a windowed proof 1240 that spans one or more entangled steps (e.g., E₁ 1220 through E₃ 1224) and that opens against either a previously trusted anchor or a provided periodic anchor 1250-1252. During replay, the verifier confirms for each step that: the disclosed host signature is valid for the executing host; the host mutation token i opens to the recorded DDHᵢ (e.g., 1210, 1212, 1214) under local policy; the successor DAH recomputed from the disclosed materials matches the recorded successor; and the cumulative chain value at the end of the window opens to the trusted anchor. Successful reconstruction yields acceptance 1260; any inconsistency produces a tamper finding 1270 recorded to local memory.

The cumulative validation is agnostic to the unpredictability source used at each host. In the hardware-anchor embodiment, per-step freshness is enforced by non-repeating salts bound to a static device identifier; in the local-state embodiment, freshness derives from extractor outputs over stability-tuned local state vectors; in the hybrid embodiment, both contributions are concatenated, and failure of either contribution is sufficient to reject the step. Because validation proceeds by local replay from prior trusted points using bounded proofs and anchors 1250-1252, the mechanism tolerates disconnected or asynchronous operation and does not depend on external registries or synchronized ledgers.

Where agents traverse administrative or trust boundaries, the scope tag 1235 enables policy-aware acceptance without global coordination: a verifier may require that steps carrying particular scope tags be corroborated by specific host roles or quorum attestations before the window 1240 is accepted. By binding every agent-side mutation to a specific host DDH (1210, 1212, 1214) and chaining those steps into the cumulative path 1230 with periodic anchors 1250-1252, FIG. 12 demonstrates end-to-end, multi-node provenance that is verifiable, replay-resistant, and tamper-evident using only locally available materials and bounded disclosures.

### 8. Recovery from Memory Loss: Quorum-Based Reauthorization

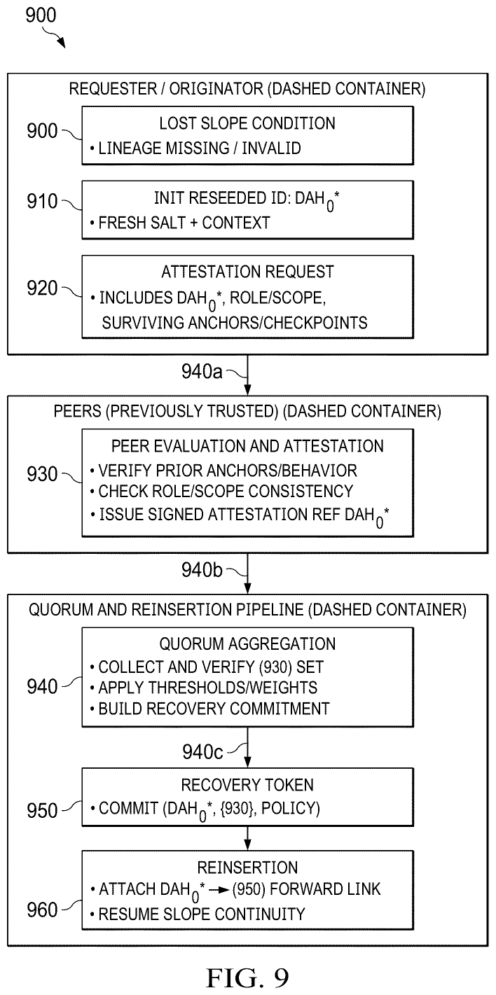

FIG. 9 illustrates a process 900 for recovery of an agent's trust slope after memory loss, entropy corruption, or discontinuity, using attestations from previously trusted peers rather than persistent credentials. An agent that detects the absence or invalidity of its stored lineage initializes a reseeded identity DAH₀* 910 and emits an attestation request 920 to peers known from prior interactions; the request is transmitted as a signed semantic agent carrying the new identity state, role and scope metadata, and any surviving anchors or checkpoint references. The lost-slope condition 900 marks the start of the recovery process; arrows 940a-940c indicate process flows rather than hardware links.

Each peer node evaluates the request 920 against locally retained evidence of prior continuity, including stored checkpoints and anchors, observed mutation classes, and execution context recorded in lineage logs. In embodiments employing stability-tuned local state vectors, a short distance sketch of the requester's prior extractor outputs may be included to support bounded similarity checks without revealing raw local state; in hardware-anchor embodiments, freshness and cadence relative to prior salts are verified. A peer that finds the request consistent within policy tolerances issues a signed attestation 930 in the form of a semantic agent that references the requester's DAH₀* 910, cites the most recent trusted anchor or checkpoint for the requester, and records the peer's own device identity and time of evaluation.

Attestations 930 are accumulated and aggregated 940 under a quorum policy. In one embodiment, the aggregation step forms a recovery token 950 computed as a commitment over the requester's DAH₀* 910, the set of validating attestations, and a policy identifier specifying quorum thresholds and weighting. The quorum policy may be defined by an adaptive consensus protocol, with eligibility, vote weights, and minimum counts determined by a referenced policy agent; the same process supports both count-based thresholds and trust-weighted thresholds that incorporate peer reputation or role scope.

Upon meeting the quorum requirements, the recovery token 950 is accepted as a successor anchor for the requester's identity and is appended into the requester's lineage. Reinsertion 960 attaches the requester to the distributed trust graph with a forward link from DAH₀* 910 to the accepted recovery anchor embodied by the token 950, enabling downstream verifiers to bridge the pre-loss and post-loss segments under local policy. Where insufficient attestations are received or where conflicts are detected, the requester remains quarantined or is directed to retry after additional observations.

The recovery mechanism is agnostic to the unpredictability source used to form the requester's new identity. In the hardware-anchor embodiment, DAH₀* 910 is derived from a static anchor and a volatile salt; in the local-state embodiment, DAH₀* 910 is derived from an extractor over a stability-tuned local state vector and a volatile salt; in a hybrid embodiment, both contributions are included. Peer evaluation remains local and deterministic in all cases, relying on previously retained checkpoints, anchors, and lineage evidence rather than external registries or static key material.

Verification of the recovery token 950 by third parties proceeds by opening the aggregated attestations 930 against the signers' identities and recomputing the commitment embodied by 950. Acceptance requires that the attesters be eligible under the referenced policy, that their signatures be valid, and that the attested linkage from the requester's pre-loss anchors to DAH₀* 910 satisfy the quorum thresholds. Failure to satisfy any condition results in rejection and optional trust-score adjustment for the requester or for misbehaving attesters, as dictated by local policy.

By replacing persistent secrets with quorum-backed attestations grounded in local memory and prior observation, FIG. 9 provides a reauthentication path that preserves decentralization, tolerates disconnection, and resists spoofing and replay. The recovery token 950 serves as a durable pivot point for subsequent validation, and the reinsertion step 960 restores continuity of the requester's trust slope without reliance on centralized authorities or static keypairs.

### 9. Entropy Anchor Rotation and Adaptive Slope Reinitialization

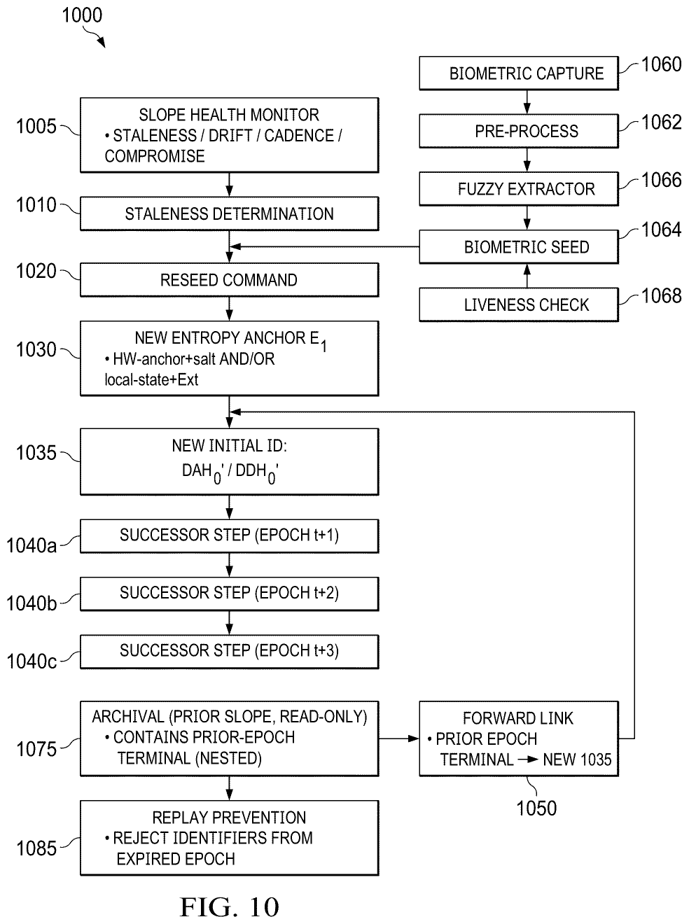

FIG. 10 illustrates a process 1000 for rotation of an entropy anchor and adaptive reinitialization of a trust slope to preserve freshness, forward secrecy, and policy alignment over time. A slope health monitor 1005 evaluates one or more indicators of staleness, including elapsed-epoch thresholds, drift or cadence anomalies in observed successors, entropy reuse heuristics, trust degradation events, or compromise signals emitted by the substrate. Upon detecting a condition that satisfies local policy, a staleness determination 1010 triggers reseeding.

In response, a reseed command 1020 initiates generation of a new entropy anchor E₁ 1030 and a corresponding initial identity DAH₀′ or DDH₀′ 1035. In a hardware-anchored embodiment, E₁ 1030 is derived from a keyed function of a static device identifier and a fresh volatile salt; in a local-state embodiment, E₁ 1030 is derived from a stability-tuned local state vector transformed by a strong extractor; in a hybrid embodiment, both contributions are included within the same derivation. The new initial identity 1035 is computed under the same update rule used throughout this disclosure with a versioned domain separator to distinguish anchor epochs.

After anchor rotation, execution proceeds along a new trust slope indicated by process arcs 1040a-1040c. To preserve verifiability across the transition, a forward link 1050 is recorded that binds the terminal value of the prior anchor epoch to the new initial identity 1035. The forward link 1050 enables downstream verifiers to reconcile pre-rotation and post-rotation segments under policy without requiring global coordination or persistent registries.

Rotation policy may sandbox or expire the prior slope. In one embodiment, the node designates the pre-rotation lineage as read-only and unavailable for future successor acceptance, marks it for archival 1075, and enforces replay prevention 1085 by rejecting presentations that reuse identifiers from the expired epoch. In another embodiment, a grace window permits parallel acceptance of both epochs solely for bridging proofs that open through the recorded forward link 1050.

Certain embodiments support biometric-assisted reseeding as an optional source of fresh local unpredictability. A biometric capture 1060 (e.g., fingerprint, voiceprint, retinal, gait, or behavioral feature) is pre-processed at step 1062 and transformed by a privacy-preserving fuzzy extractor 1066 to yield a bounded seed 1064; optional liveness verification 1068 may be applied. The seed 1064 is never stored or exported in raw form and is used only locally to derive or augment the new anchor E₁ 1030. The biometric-assisted path composes with both the hardware-anchored and local-state embodiments by contributing additional non-exported unpredictability to the reseed command 1020.

Validation under rotation is local and deterministic. A verifier that encounters a rotated identity requests or receives bounded proofs that include the forward link 1050 and the new initial identity 1035; the verifier then replays successors along arcs 1040a-1040c and confirms that the new epoch opens to the prior epoch through 1050 in accordance with policy. Because E₁ 1030 and 1035 are produced by the same permitted sources-hardware anchor with volatile salt, local state vector with extractor, or hybrid—the verification logic is uniform across epochs.

In privacy-sensitive deployments, the DAH presented in transport headers may rotate at a policy-defined cadence independent of payload semantics to reduce linkability. Verifiers reconcile rotations by opening forward links or anchors recorded for each header epoch, preserving auditability while limiting long-range correlation.

As depicted in FIG. 10, entropy anchor rotation thus maintains high-entropy, memory-resolved identity across a device or agent's operational lifetime. The slope health monitor 1005 detects staleness 1010, reseeding 1020 establishes a new anchor 1030 and initial identity 1035, execution continues along a fresh slope 1040a-1040c, and the forward link 1050 preserves auditable continuity while enabling expiration 1075 and replay protection 1085 for the prior epoch. All arrows indicate process flows rather than hardware connections.

### 10. Delayed Validation for High-Latency and Intermittent Systems

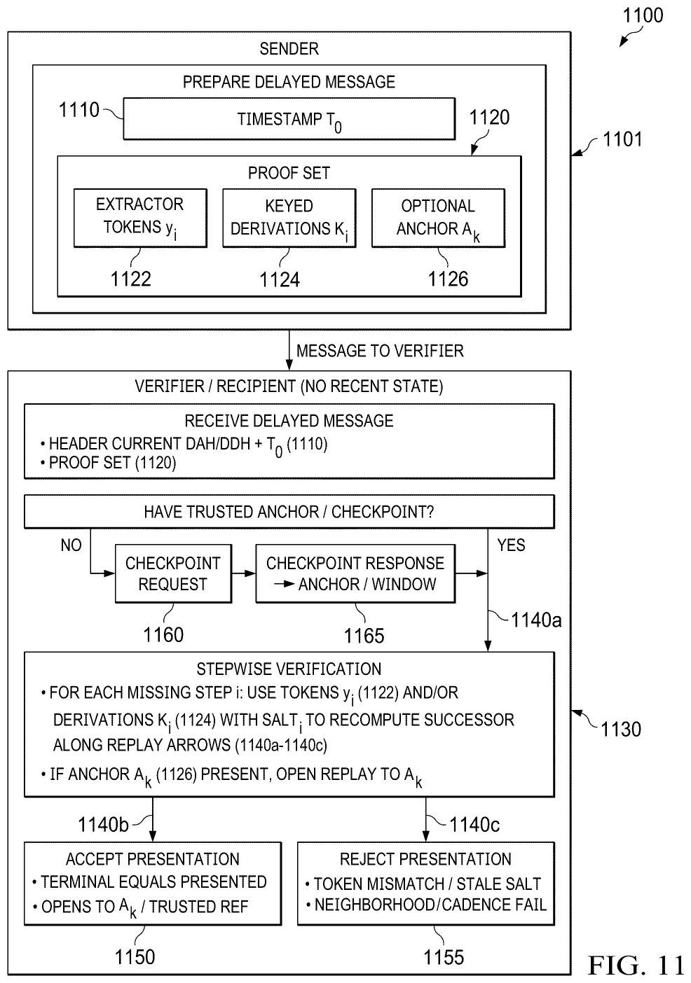

FIG. 11 illustrates a process 1100 for delayed validation in environments where immediate continuity checking is impracticable due to latency, intermittent connectivity, or disconnection. A sender 1101 prepares a message bearing the sender's current dynamic identity and a transmission timestamp T₀ 1110, together with a bounded set of mutation proofs 1120 that compactly represent the intervening trust-slope evolution since a previously trusted anchor. The proofs 1120 enable downstream reconstruction without requiring continuous synchronization or external registries.

In one embodiment, the set of mutation proofs 1120 includes, for each missing step i in the transmission window, per-step materials sufficient to deterministically recompute the successor: an extractor token yᵢ 1122 derived from a stability-tuned local state vector with a per-step volatile salt, when the local-state embodiment is used; a keyed derivation κᵢ 1124 computed from a static hardware anchor and a per-step volatile saltᵢ, when the hardware-anchor embodiment is used; or both 1122 and 1124, when a hybrid embodiment is used. The sender may also include an optional reference to the last periodic anchor Aₖ 1126 or a checkpoint identifier to assist bounded replay.

Upon receipt, a verifier that lacks a recent anchor 1130 replays the intervening steps by iteratively applying the update rule with the disclosed per-step materials along process arcs 1140a-1140c, starting from its last trusted value and proceeding forward to the presented identity associated with T₀ 1110. For each step, the verifier recomputes the successor from the immediately prior value and the disclosed token(s) and salt, and, when local-state tokens are used, may evaluate a neighborhood constraint under local policy to bound drift. When the chain opens to Aₖ 1126 or to the stored reference and the recomputed terminal value equals the presented value, validation succeeds and the presentation is accepted 1150.

If the verifier's stored state predates Aₖ 1126 or if the supplied proof set 1120 is insufficient to complete the replay, the verifier issues a checkpoint request 1160 and receives a bounded checkpoint response 1165 comprising either a newer anchor reference or an additional short proof window. Because each successor depends only on the immediately prior dynamic identity and the disclosed per-step materials, delayed verification remains local and stateless once the checkpoint is obtained.

If replay fails—because a per-step token is inconsistent, a salt is stale relative to expected cadence, a neighborhood constraint is violated, or the recomputed terminal value does not match the presented value—the verifier rejects the presentation 1155 under policy. Optional actions include trust-score adjustment or quarantine pending subsequent corroboration from anchors or peers.

The delayed validation mechanism is agnostic to unpredictability source. In the hardware-anchor embodiment, the proofs 1120 convey keyed derivations 1124 that bind freshness to per-epoch salts; in the local-state embodiment, the proofs 1120 convey extractor tokens 1122 derived from stability-tuned local state vectors; in the hybrid embodiment, both are conveyed and concatenated in the update rule, and failure of either contribution is sufficient to reject the step. In all cases, acceptance 1150 requires strict monotonic progression within the proof window and prevents replay by disallowing reuse of previously accepted successors for the same sender and context.

When header-level continuity validation succeeds yet payload decryption fails due to recipient identity drift, the recipient advertises its current anchor or checkpoint and the sender retries once using that anchor; failing that, the sender requests a bounded checkpoint response. Retries are limited by policy to a fixed attempt window to avoid oracle leakage while ensuring bootstrapping from sparse state.

By allowing receivers to authenticate from sparse local state using bounded proof windows and optional checkpoints, the process outlined in FIG. 11 enables secure operation in stateless, intermittently connected, or long-duration disconnected deployments while preserving the memory-resolved authentication model and avoiding reliance on persistent credentials, centralized authorities, or synchronized ledgers.

### 11. Sparse Trust Slope Recovery Using Embedded Checkpoints

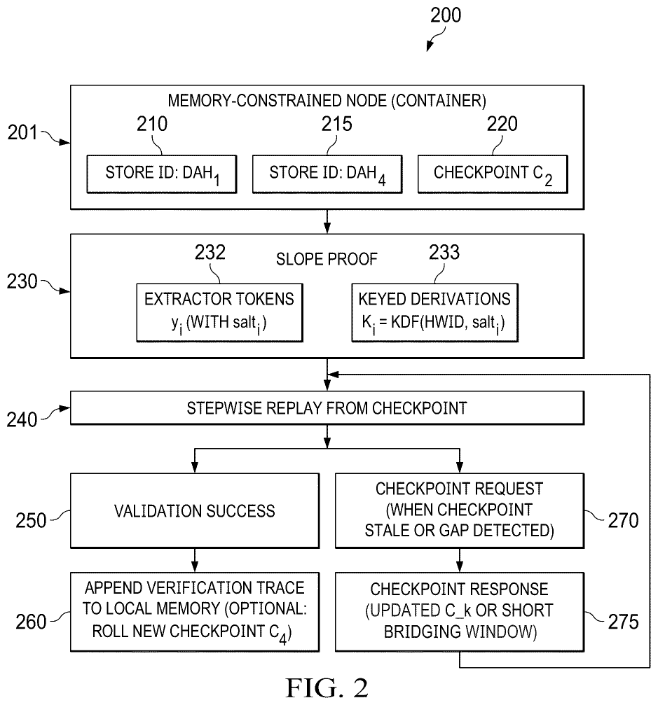

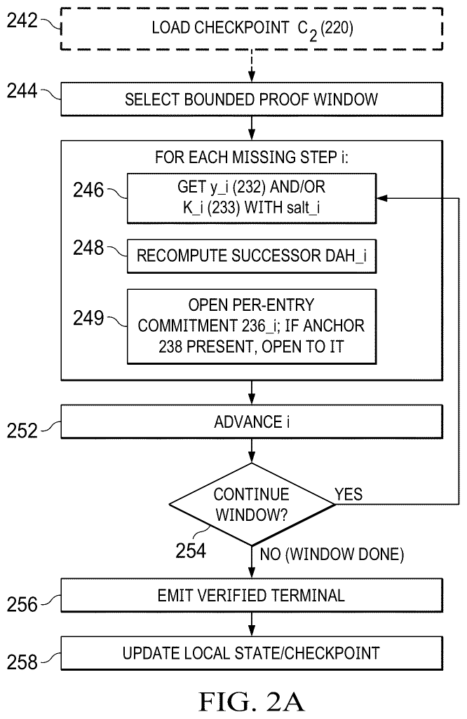

FIG. 2 illustrates a process 200 for sparse recovery of a trust slope in memory-constrained deployments using embedded checkpoints and bounded proofs. A device or agent 201 retains selected identities such as DAH₁ 210 and DAH₄ 215 together with a checkpoint C₂ 220 that summarizes all validated mutations up to the checkpoint epoch. When continuity must be re-established from limited local state, a slope proof 230 provides only the per-step materials for the missing interval, allowing deterministic forward replay from C₂ 220 via a summarized replay group 240, with the per-step procedure unrolled in FIG. 2A.

FIG. 2A depicts the unrolled procedure corresponding to the replay group 240 of FIG. 2. The verifier loads checkpoint C₂ 220 (step 242), selects a bounded proof window (step 244), and for each missing step i (step 245) obtains extractor token yᵢ 232 and/or keyed derivation Kᵢ 233 with saltᵢ (step 246). The verifier recomputes the successor DAHᵢ (step 248) and opens the per-entry commitment 236ᵢ; when a periodic anchor 238 is present the replay is opened to the anchor (step 249). The replay index is advanced (step 252) and continuation is evaluated under the bounded window (step 254), where it is determined whether to continue window. If yes, return to step 246; if no, the window is done and so, upon this completion, a verified terminal for the window is emitted (step 256) and local state is updated for subsequent acceptance or checkpointing (step 258).

In one embodiment, the proof 230 includes, for each step i after C₂ 220, an extractor token bundle 232 comprising yᵢ=Ext(Xᵢ) with a per-step volatile salt, when the local-state embodiment is used; in another embodiment, the proof includes a keyed-derivation bundle 233 comprising KDF(HWID, saltᵢ) when the hardware-anchor embodiment is used; in a hybrid embodiment, both 232 and 233 are present and concatenated. The verifier recomputes successors as DAHᵢ₊₁=H(DAHⁱ∥tokenᵢ∥saltᵢ∥tag) until the presented value (e.g., DAH₄ 215) is reached.

Each step in the missing interval is also committed for tamper evidence. A per-entry commitment 236ᵢ=H(DAHᵢ∥tokenᵢ∥metaᵢ) is folded into periodic anchors 238 at window size J. The proof 230 supplies the siblings necessary to open 236ᵢ against C₂ 220 and the relevant anchor 238, yielding validation success 250 when the recomputed chain matches the presentation. The verifier appends a verification trace to local memory 260 and may roll a new checkpoint C₄ for future sparse recovery.

If the stored checkpoint is stale or unavailable, the verifier issues a checkpoint request 270 and receives a bounded checkpoint response 275 containing either an updated checkpoint Cₖ or a short bridging proof window to the nearest trusted anchor. Because each successor depends only on the immediately prior DAH and the disclosed per-step materials (232, 233), reconstruction proceeds locally and does not require external registries, static credentials, or synchronized ledgers.

The checkpoint mechanism is agnostic to unpredictability source. In the hardware-anchor embodiment, freshness is enforced through per-epoch salts bound to a static device identifier and verified via 233; in the local-state embodiment, freshness derives from stability-tuned extractor tokens 232, optionally accompanied by a compact distance sketch evaluated at replay; in the hybrid embodiment, both contributions must verify for acceptance. Policy controls the checkpoint cadence, trading storage overhead against replay effort: more frequent C_* checkpoints reduce reconstruction cost, while sparser checkpoints minimize storage at the expense of longer bounded proofs.

By retaining sparse identities (210, 215), embedding checkpoints (220), verifying bounded proofs (230 with 232/233), opening commitments and anchors (236, 238), and supporting cursor movement via requests and responses (270, 275), the process outlined in FIG. 2 allows for verifiable recovery of identity continuity in memory-constrained or intermittently connected environments using only locally available materials and policy-bounded disclosures.

### 12. Predictive Mutation Verification and Behavioral Drift Detection

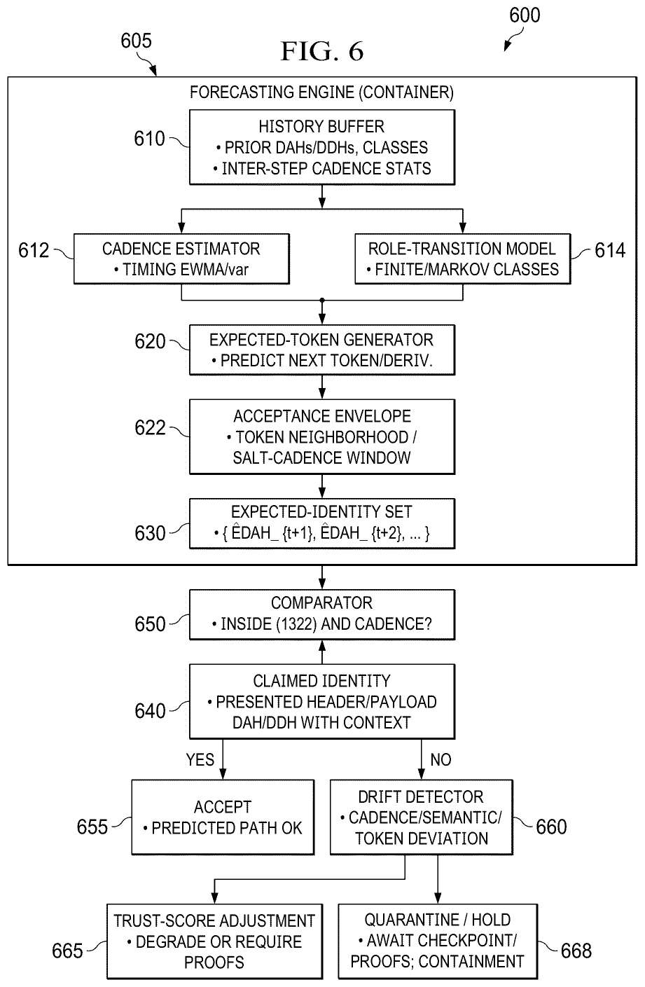

FIG. 6 illustrates a process 600 for predictive validation of agent and device identity by forecasting expected successor states and bounding acceptable deviation to detect drift or compromise prior to full slope discontinuity. A forecasting engine 605 operates over a history buffer 610 comprising prior validated dynamic identities, mutation classes, and inter-step cadence statistics. From this buffer, a cadence estimator 612 and a role-transition model 614 produce forecast parameters for near-future epochs.

In one embodiment, the cadence estimator 612 maintains an exponentially weighted moving average of inter-step intervals and a variance term to predict the expected timing window for the next successor. The role-transition model 614 encodes a finite-state transition matrix implementing a first-order Markov chain, in which each row specifies the conditional probabilities of transitioning from a current mutation class, semantic role, or scope tag to a successor class; the matrix is row-stochastic with nonnegative entries that sum to one. These predictions yield a most-likely mutation class \hat{m}_{t+1} and a small set of alternates. The predicted attributes drive an expected-token generator 620 that forms a neighborhood envelope 622 for the next step on the trust slope.

The expected-token generator 620 is compatible with both identity sources. In a local-state embodiment, it projects recent local-state feature vectors into a stability-tuned space and computes a predicted extractor token \hat{y}{t+1} together with an acceptance envelope 622 defined as a Hamming ball of radius r around \hat{y}{t+1} (i.e., all tokens whose Hamming distance from \hat{y}{t+1} is <r), with r calibrated to observed intra-role variation. In a hardware-anchor embodiment, it predicts salt freshness and cadence bounds for the next per-epoch derivation, yielding an acceptance window over salt reuse and timing. In a hybrid embodiment, both the \hat{y}{t+1} Hamming-ball envelope and the salt-cadence window are produced, and both must be satisfied during verification.

The forecasting engine 605 emits an expected-identity set 630 that may include one or more predicted successors \wide\hat{\mathrm{DAH}}{t+1}, \wide\hat{\mathrm{DAH}}{t+2}(or \wide\hat{\mathrm{DDH}}_{\cdot} for devices) together with their acceptance envelopes 622 and expected inter-step timing. Upon receipt of a presentation bearing a claimed identity 640 (e.g., header DAH or embedded sender DAH as previously described), a comparator 650 evaluates whether the claim lies within the predicted envelope and within the cadence window. If so, the claim is classified as predicted-trajectory consistent and accepted 655 subject to normal continuity checks.

Deviations are evaluated as behavioral drift. A drift detector 660 classifies out-of-envelope claims by type, including cadence anomalies (early/late relative to the estimator 612), semantic divergence (unexpected mutation class relative to 614), and token-space deviation (exceeding the acceptance envelope 622 in the local-state embodiment). Policy actions may include trust-score adjustment 665, requirement for supplemental proof (e.g., a short bounded window from the sender), or quarantine 668 pending corroboration from peers or anchors.

Predictive verification composes with delayed or sparse validation. When a verifier lacks an up-to-date anchor, it may still use the expected-identity set 630 to triage incoming traffic: claims far outside envelopes are rejected or quarantined immediately, while near-boundary claims are held until a checkpoint or short proof window arrives. Once checkpoint material is available, standard replay from the last trusted state confirms or refutes the prediction without reliance on external registries or static credentials.

The predictive mechanism is agnostic to unpredictability source. In the hardware-anchor embodiment, the comparator 650 enforces salt freshness and cadence windows predicted by 612; in the local-state embodiment, it enforces neighborhood envelopes computed from stability-tuned projections; in the hybrid embodiment, both must hold. Forecast parameters are continuously updated from the history buffer 610 as new validated steps arrive, allowing the envelopes 622 to tighten or relax adaptively with observed behavior while preserving sensitivity to genuine role changes indicated by the transition model 614.

This combination of the forecasting engine 605, cadence estimator 612, role-transition model 614, expected-token generator 620 with acceptance envelopes 622, comparator 650, drift detector 660, and policy outcomes 655/665/668 provides early, local detection of compromise or unauthorized mutation while maintaining interoperability with the trust-slope continuity checks disclosed herein. Arrows in FIG. 6 indicate process flows rather than hardware connections.

### 13. Compatibility with Legacy Systems Using Fallback Identifiers

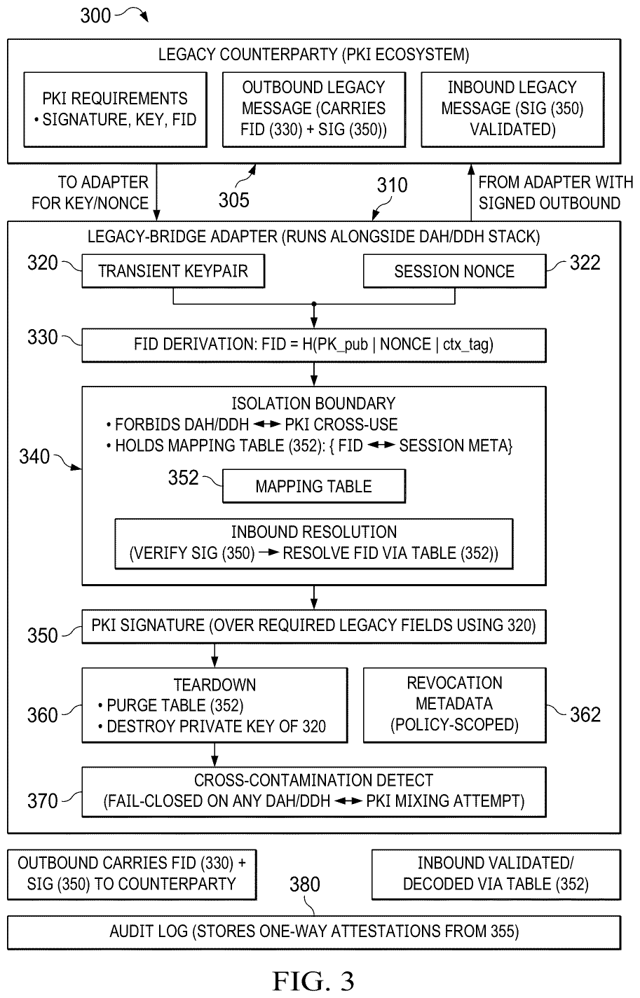

FIG. 3 illustrates a process 300 that allows for interoperability with legacy systems that rely on persistent public-private keypairs and PKI-style signatures, while preserving isolation from the memory-resolved trust slope. A fallback identifier is constructed for the sole purpose of a legacy session and is cryptographically segregated from Dynamic Agent Hash (DAH) and Dynamic Device Hash (DDH) evolution.

In one embodiment, a legacy-bridge adapter 310 generates a transient keypair 320 and a session nonce 322 scoped by a domain-separating context tag. The adapter derives a fallback identifier FID 330 as FID=H(PK_pub∥nonce∥ctx_tag), where PK_pub is the public key of 320. The FID 330 is maintained inside an isolation boundary 340 that prevents any use of PK_pub, the nonce 322, or the FID 330 in DAH/DDH update rules. A local, volatile mapping table 352 records {FID 330↔session metadata} for the duration of the session only.

For outbound interoperability, the adapter 310 composes a legacy message that carries FID 330 and a PKI signature 350 over the required legacy fields using the private key of 320. Transport and acceptance by the legacy counterparty proceed under its PKI policy 305, while the sender's DAH/DDH slope remains unchanged and continues to govern local routing, caching, or semantic authorization. No fallback material is hashed into DAH/DDH, and no DAH/DDH material is exported to the legacy side.

For inbound interoperability, the adapter 310 validates the counterparty's PKI signature 350 and resolves it to a local FID 330 via the mapping table 352. If local policy requires correlating the legacy session to a current DAH_t for auditing, the adapter may mint a one-way binding token 355 that attests “FID 330 was serviced while DAH_t was active,” without allowing any legacy-sourced material to influence successor computation on the trust slope. The binding token 355 is stored in a segregated audit log 380 and expires with the session.

Fallback lifecycle is strictly bounded. At session termination or policy-defined expiry, the adapter purges the mapping table entry 352, destroys the transient private key of 320, and marks FID 330 invalid via teardown 360. Optional revocation metadata 362 can be emitted to prevent reuse by intermediaries. Because no DAH/DDH update ever incorporates PKI artifacts, teardown 360 cannot perturb the trust slope.

The isolation boundary 340 enforces non-contamination in both directions. Cross-contamination detection 370 fails closed if any attempt is made to (i) inject PKI-derived values into DAH/DDH successors, (ii) export DAH/DDH internals to satisfy legacy authentication, or (iii) extend a legacy identifier beyond its declared context. Policy may additionally constrain fallback use to whitelisted legacy domains or require human-in-the-loop approval for high-sensitivity scopes.

The mechanism is agnostic to unpredictability source. Whether DAH/DDH is formed from a hardware anchor with volatile salt, a local state vector with extractor, or a hybrid of both, the legacy bridge 310 operates purely at the adapter boundary and does not alter slope formation, continuity checks, lineage chaining, delayed verification, or checkpoint replay.

By confining FID 330 and PKI signature 350 to a segregated adapter path with explicit teardown 360, and by recording only one-way attestations 355 in an audit log 380, FIG. 3 demonstrates compatibility with legacy ecosystems without diluting memory-native authentication or enabling persistent surveillance of identity evolution. Arrows in FIG. 3 indicate process flows rather than hardware connections.

### 14. Cryptographic Threat Model and DSM Defense Surface

The Dynamic Signature Mesh (DSM) defines an adversarial model and corresponding defense surface for memory-resolved authentication in decentralized substrates. Unlike public-key infrastructures that depend on persistent private keys and hierarchical anchors, DSM validates identity as deterministic progression along a trust slope whose successors are derived from locally retained unpredictability and semantic context. The model applies to embodiments that derive dynamic identities from a hardware anchor with per-epoch volatile salt, from a stability-tuned local state vector processed by a strong extractor, or from a hybrid that concatenates both sources.

Resistance to static-key compromise follows directly from the absence of long-lived secrets in the authentication path. A Dynamic Agent Hash (DAH) or Dynamic Device Hash (DDH) is ephemeral, computed per step, and never reused as a standing credential. Observation or disclosure of any single DAH/DDH does not enable impersonation because acceptance requires monotonic progression from a prior trusted state under the published update rule and policy-bounded continuity checks.

Spoofing and impersonation are mitigated by on-slope continuity verification and substrate entanglement. A claimant must present a successor that is a valid descendant of the verifier's last trusted state and, for agent mutations, must open the host entanglement trace that binds the step to a specific device identity at execution time. In the hardware-anchor embodiment, per-epoch salts and cadence bounds prevent reuse; in the local-state embodiment, neighborhood envelopes over extractor outputs enforce role-consistent drift; in the hybrid embodiment, failure of either contribution is sufficient to reject the claim.

Replay is prevented by enforcing non-repetition within a policy horizon and by requiring forward movement along the slope. Presentations equal to previously accepted successors, regressions behind the verifier's stored reference, or claims outside the expected inter-step timing window are rejected and may trigger automatic trust degradation or quarantine as specified by local policy.

Message-layer integrity composes with identity verification through two-stage authentication. A transport header DAH is screened for continuity prior to decryption; the payload is then decrypted under a key derived from the recipient's current identity and must contain an embedded copy of the sender's DAH that is itself validated against the sender's slope. Failure at either stage yields deterministic rejection and optional policy actions without reliance on external registries.

Tamper detection over historical evolution is provided by forward-secure commitments and periodic anchors on lineage logs. Each entry folds into a cumulative chain; omission, reordering, or modification of any entry diverges the terminal value and fails opening against the last anchor. Sparse and delayed verification remain secure because bounded proof windows disclose only per-step materials sufficient for local recomputation and commitment opening, never raw local state vectors or static device secrets.

Quantum threats are addressed by avoiding hardness assumptions vulnerable to Shor's algorithm. Security reduces to the unpredictability of per-step inputs and the preimage resistance of the employed hashes and extractors. Let λ denote the min-entropy (in bits) of the per-step unpredictability contribution after extraction; an offline next-step forgery then has success probability approximately 2\hat{ }{−λ}(i.e., two raised to the negative X). In the presence of quantum amplitude-amplification search (e.g., Grover's algorithm), generic attacks achieve only a quadratic speedup, yielding success probability approximately 2\hat{ }{−λ/2}. Parameter selection (e.g., 256-512-bit extractor outputs and 256-512-bit hash digests) provides conservative margins.

Side-channel and co-residency risks are bounded by locality and diversification. In the hardware-anchor embodiment, salts are single-use and bound to epochs, preventing cross-context replay even if a salt is observed. In the local-state embodiment, only short, error-tolerant sketches may be disclosed for neighborhood checks; sketches are non-invertible and insufficient to reconstruct raw state. Optional biometric reseeding augments, but never replaces, these sources and is confined to privacy-preserving fuzzy extractors with liveness verification.

Host compromise and off-substrate mutation are contained by entanglement and signatures on mutation traces. A verifier requires that each agent-side mutation include a host-signed trace whose mutation token opens to the asserted host DDH under policy; steps lacking a coherent entanglement proof fail closed. Entropy-anchor rotation with forward links permits proactive refresh without abandoning auditability and prevents stale-epoch replay across anchor boundaries.

Cross-protocol and downgrade attacks are mitigated by strict isolation of legacy interoperability. Fallback identifiers and PKI signatures are confined to a segregated adapter whose materials are never hashed into DAH/DDH updates; any attempted mixing of PKI artifacts with slope formation triggers fail-closed detection. Session-scoped mappings and explicit teardown prevent persistence or surveillance across epochs.

Flooding and admission-control threats are addressed by early discard on header continuity failure, by mandatory replay protection, and by policy-driven rate limits keyed to sender slope state. Nodes may degrade trust on repeated near-misses, require supplemental bounded proofs, or quarantine sources exhibiting cadence or neighborhood anomalies.

To constrain cross-correlation and token malleability, extractor tokens and any optional sketches are domain-separated by a fixed public seed and context tag per deployment and are never reused across domains. Validation applies policy-defined acceptance envelopes that bound token-space neighborhoods; presentations outside the envelope are classified as off-manifold drift and fail closed without disclosing raw local state vectors.

Receivers implement a two-epoch acceptance window (current epoch and immediately prior) and per-sender rate limits keyed to header continuity to mitigate denial-of-service conditions when senders encrypt under stale recipient identities. Failure responses are opaque and do not leak rekey status; repeated failures degrade trust under policy and may require a checkpoint-based retry before further processing.

Linkability is further constrained by header-level DAH rotation on a fixed cadence with forward links, preventing persistent correlation of activity while maintaining verifiable continuity under bounded proofs.

Collectively, these mechanisms establish a defense surface that resists static-key compromise, spoofing, replay, mutation tampering, predictive entropy attacks, quantum acceleration, host compromise, and cross-protocol contamination while remaining compatible with stateless, intermittent, and federated operation. The protections operate uniformly across hardware-anchor, local-state, and hybrid embodiments and require only locally available materials, checkpoints, and bounded disclosures.

### 15. Deployment Environments and Cognition-Native Adaptability

The disclosed mechanisms are deployable across heterogeneous substrates, including stateless execution fabrics, intermittently connected networks, memory-constrained devices, decentralized multi-domain systems, and cognition-native agent platforms. In all such environments, identity is validated as progression along a trust slope formed from locally retained unpredictability and semantic context, without reliance on centralized authorities, long-lived credentials, or synchronized ledgers.

In stateless deployments-such as ephemeral edge workers, serverless functions, relay nodes, and mobile agents operating without durable storage—the system derives Dynamic Agent Hashes (DAHs) and Dynamic Device Hashes (DDHs) directly from locally available inputs under the update rules disclosed herein. A minimal conformance profile executes header continuity screening prior to decryption, derives a symmetric key from the recipient's current identity, and appends bounded validation traces; optional checkpointing provides later reconstruction when persistent storage is unavailable. Because no private key material or session state must be preserved across invocations, stateless operation remains fully interoperable with memory-aware peers.

In high-latency, disrupted, or disconnected networks-such as delay-tolerant, mesh, opportunistic, or spaceborne links—the system authenticates using delayed verification and bounded proof windows. Senders embed per-step materials sufficient for local replay from the verifier's last anchor; receivers reconstruct continuity upon reconnect without global synchronization. Sparse proofs and periodic anchors permit long-haul transit while preserving auditability and replay resistance.

In memory-constrained devices-including IoT sensors, wearables, embedded controllers, and ultra-low-power endpoints—the system employs sparse checkpointing and forward-secure chaining to bound storage overhead. Devices retain only selected identities and anchors, reconstructing intervening steps on demand from compact proofs. Policy controls checkpoint cadence to trade storage for replay effort, and acceptance remains strictly local and deterministic.

In decentralized and cross-domain environments-such as federated learning, distributed AI ecosystems, or multi-tenant data exchanges—the system supplies a substrate-independent trust layer. Nodes validate each other via memory-resolved behavior rather than external registries, enabling organic formation of trust graphs across administrative boundaries. Agent-side mutations are entangled to the executing host's device identity, yielding verifiable provenance during migration and preventing off-substrate evolution.

In cognition-native platforms where agents are semantic, memory-bearing operands with intent fields and policy references, trust-slope continuity ties identity to behavioral integrity rather than static credentials. Agents can mutate, delegate, reclassify, or reindex under embedded policy while preserving verifiable lineage through entanglement traces, append-only mutation logs, and cumulative anchors. Predictive verification further anticipates near-term successors to surface drift prior to full discontinuity, improving containment and triage.

The mechanisms are agnostic to unpredictability source. In one embodiment, per-step freshness is derived from a hardware anchor combined with a volatile salt; in another embodiment, from a stability-tuned local state vector processed by a strong extractor; in a hybrid embodiment, both sources are concatenated in the update rule. Optional entropy-anchor rotation with forward links renews identity epochs without sacrificing auditability, and biometric-assisted reseeding may supply additional local unpredictability via privacy-preserving extractors and liveness checks.

Because identity formation depends on local unpredictability, hash-based commitments, and bounded proofs—rather than hardness assumptions targeted by Shor-type attacks—the deployment model is inherently post-quantum aligned. Isolation of legacy interoperability to a segregated adapter prevents cross-protocol contamination, while two-stage authentication and strict replay controls provide early discard under load. Collectively, these properties support privacy preservation, operational autonomy, and verifiable provenance across next-generation distributed, stateless, and intelligent infrastructures.

### 16. Definitions

As used herein, “agent” refers to a cryptographically signed, memory-bearing data object that acts as a protocol operand within the disclosed substrate. An agent includes a unique identifier, a payload, a memory field, a transport header, and a signature, and participates in trust-slope formation and validation as described herein.

As used herein, “semantic agent” refers to a specialized agent that additionally comprises an intent field and cognition-compatible structure enabling policy-aware mutation, delegation, and context-sensitive execution. All semantic agents are agents, but not all agents are semantic agents.

As used herein, “policy agent” refers to an agent that encodes quorum rules, mutation eligibility criteria, role definitions, and related controls. A policy agent may be referenced from another agent's memory field to govern eligibility, weighting, and thresholds during validation or consensus.

As used herein, “substrate,” “host,” or “node” refers to a computational device or execution environment that processes agents and maintains a Dynamic Device Hash for its own identity state.

As used herein, “Dynamic Agent Hash (DAH)” refers to an ephemeral, memory-resolved cryptographic identifier generated by an agent as a successor of a prior trusted DAH under an update rule that incorporates at least one unpredictability contribution and a volatile salt, together with optional agent-side semantic features.

As used herein, “Dynamic Device Hash (DDH)” refers to an ephemeral, memory-resolved cryptographic identifier generated by a device as a successor of a prior trusted DDH under an update rule that incorporates at least one unpredictability contribution and a volatile salt, together with optional device-side role or context features.

As used herein, “trust slope” refers to the cumulatively validated sequence of DAHs or DDHs formed by successive, verifiable identity mutations. Trust-slope continuity denotes that a presented successor is a valid descendant of a previously trusted state under policy-bounded checks.

As used herein, “entropy” refers to locally available unpredictability used in successor formation and validation. In one embodiment, entropy is derived from a static hardware anchor combined with per-epoch volatile salts; in another embodiment, entropy is derived from a stability-tuned local state vector transformed by a strong extractor; in a hybrid embodiment, both sources are concatenated. For parameterization, X denotes the effective min-entropy of the per-step contribution after extraction.

As used herein, “entropy anchor” refers to the initial unpredictability state from which a trust slope originates for an agent or device. Anchors may be rotated proactively or reactively and may be linked forward to subsequent epochs for auditable continuity.

As used herein, “local state vector (LSV)” refers to a bounded-dimension vector of locally observable device or execution signals (e.g., counters, timing jitter, I/O micro-variation, process mix features, or analogous signals) that, after normalization and projection, yields a stability-tuned representation suitable for extraction without exposing raw state.

As used herein, “extractor” or “strong randomness extractor” refers to a cryptographic function that derives a fixed-length, high-entropy token from the projected local state vector or other noisy input; the resulting extractor output is used in successor computation or disclosed in bounded proofs without revealing the underlying state.

As used herein, “volatile salt” refers to a non-repeating freshness value scoped to a successor step or epoch and combined with other per-step inputs to prevent replay and cross-context reuse.

As used herein, “host mutation token” refers to a value derived from the executing host's current DDH together with mutation class or epoch information, used to entangle an agent-side successor to the host on which the mutation occurred.

As used herein, “slope entanglement” refers to the process by which an agent's successor DAH is cryptographically bound to the executing host's contemporaneous DDH via a host mutation token and a signed entanglement trace.

As used herein, “entanglement trace” or “lineage entry” refers to a signed record appended to an agent's memory capturing the prior DAH, the host DDH, the host mutation token, the successor DAH, the mutation class, and associated metadata for that mutation step.

As used herein, “cumulative chain hash” refers to a forward-secure digest computed over the ordered lineage entries such that omission, reordering, or modification of any entry is detected by divergence of the terminal cumulative value.

As used herein, “anchor” refers to a periodic digest computed at selected intervals over lineage or commitments to enable compact proofs across long histories; an anchor may be used to “open” a bounded window of entries during validation.

As used herein, “checkpoint” refers to a retained, trusted state-embedded in an agent or stored by a verifier—that allows reconstruction of missing successors using bounded proofs without retaining full history.

As used herein, “slope proof” refers to a bounded disclosure that includes per-step materials sufficient to deterministically recompute missing successors from a checkpoint or anchor without exposing raw local state or static device secrets.

As used herein, “delayed validation” refers to authenticating a presentation after an interval of disconnection or latency by replaying successors from a stored checkpoint or anchor using a supplied slope proof.

As used herein, “predictive validation” refers to forecasting near-term successors and acceptance envelopes from observed cadence, mutation classes, and role transitions, and comparing claimed successors to the forecast to detect drift prior to full discontinuity.

As used herein, “acceptance envelope” refers to a policy-defined bound used during validation or prediction—e.g., a token-space neighborhood radius in the local-state embodiment and a freshness/cadence window in the hardware-anchor embodiment.

As used herein, “recovery token” refers to a commitment over a reseeded identity and a quorum of signed attestations that, when verified under policy, re-anchors an agent's slope after memory loss or discontinuity.

As used herein, “quorum-based reauthentication” refers to recovery of slope continuity using attestations from eligible peers under a referenced policy, without reliance on persistent credentials or centralized authorities.

As used herein, “fallback identifier (FID)” refers to a session-scoped identifier derived from a transient public key and nonce for interoperability with legacy PKI systems, maintained within an isolation boundary and excluded from DAH/DDH formation.

As used herein, “two-stage authentication” refers to header-layer continuity screening of a presented DAH prior to decryption, followed by payload-layer validation of an embedded sender DAH after decryption, with failure at either stage causing rejection.

As used herein, “biometric-assisted reseeding” refers to optional contribution of local unpredictability derived from a biometric capture via a privacy-preserving fuzzy extractor with liveness verification, used only to augment reseed operations and never exported.

As used herein, “scope tag,” “role,” or “mutation class” refers to policy-relevant metadata recorded with a successor that constrains eligibility, weighting, or acceptance under local policy during validation or consensus.

As used herein, “Dynamic Signature Mesh (DSM)” refers to the memory-native authentication framework in which identity is validated as progression along trust slopes using local unpredictability, bounded proofs, and anchors, without persistent keys or centralized registrars.

As used herein, “memory-resolved identity” refers to an identity model in which authentication depends exclusively on locally retained information-including unpredictability sources, lineage evidence, and policy-scoped traces-rather than on third-party attestations or long-lived secrets.

As used herein, “Domain separation” means seeding extractors and KDFs with deployment-fixed public seeds and context tags such that tokens and keys are unlinkable across domains and epochs.

As used herein, “near real-time” or “real time” describes a process that occurs or a system that operates to produce a given result with a slight but acceptable delay between the occurrence of an event, such as an acquisition of or update to relevant data, and when the given result is produced. In the context of the present disclosure, a slight but acceptable delay is in the range of about 250 milliseconds.

“About” when used herein with reference to a value or range is used in its plain and ordinary sense as understood by persons of ordinary skill in the art as referring to standard tolerances for the referenced parameter, and when standard tolerances are not applicable, a value or range of values defined with “about” is met when a change in the range or value changes the changes the performance characteristics of the relevant parameter or the performance characteristics of the system as a whole by not more than five percent (5%).

The computer-based processing system and method described above may be implemented in any type of computer system or programming or processing environment, or in a computer program, alone or in conjunction with hardware. The present disclosure may also be implemented in software stored on a non-transitory computer-readable medium and executed as a computer program on a general purpose or special purpose computer. It is further contemplated that the present invention may be run on a stand-alone computer system, or may be run from a server computer system that can be accessed by a plurality of client computer systems interconnected over an intranet network, or that is accessible to clients over the internet.

What is claimed is:

1. A computer-implemented method for memory-native two-stage authentication, comprising:
generating, by a sender agent, a dynamic agent hash (DAH_t) as a successor of a prior trusted dynamic agent hash (DAH_{t−1}) generated by the sender agent, wherein the DAH_t is generated under an update rule that incorporates at least one unpredictability contribution and a volatile salt;
deriving, by the sender agent, a symmetric encryption key from a current dynamic identity of a recipient selected from a recipient dynamic agent hash (DAH_R) or a recipient dynamic device hash (DDH_R);
encrypting a payload with the symmetric encryption key and embedding within the encrypted payload an embedded sender dynamic agent hash (DAH_S) computed contemporaneously with the DAH_t;
constructing, by the sender agent, a message comprising a transport header and the encrypted payload, and placing the DAH_t in the transport header and the DAH_S within the encrypted payload, wherein the message does not include the symmetric encryption key;
transmitting, by the sender agent, the message to the recipient;
receiving, by the recipient, the transmitted message and reconstructing, from a locally retained trust-slope state for the sender agent that includes at least the DAH_{t−1} most recently validated and previously accepted by the recipient, an expected successor candidate for time t under the update rule and within a recipient-defined set of policy-bounded continuity parameters;
validating, by the recipient, the DAH_t against an expected successor candidate;
deriving, by the recipient, a recipient symmetric encryption key from a corresponding one of DAH_R or DDH_R and decrypting the payload;
extracting, by the recipient, the DAH_S from the decrypted payload and validating the DAH_S against a reconstructed trust slope for the sender agent obtained by advancing the locally retained trust-slope state under the update rule and within the recipient-defined set of policy-bounded continuity parameters; and
accepting, by the recipient, the message only upon successful validation of both the DAH_t and the DAH_S.

2. The method of claim 1, wherein the accepting and validating are performed without reliance on persistent private keys or external certificate authorities.

3. The method of claim 1, wherein the unpredictability contribution includes a keyed derivation from a static hardware anchor and a volatile per-epoch salt.

4. The method of claim 1, wherein the unpredictability contribution includes an extractor output over a stability-tuned local state vector, the extractor output being used without exposing a raw local state.

5. The method of claim 1, wherein the update rule includes a hardware-anchor derivation and a local-state extractor output and wherein both the hardware-anchor derivation and the local-state extractor output are concatenated in the update rule.

6. The method of claim 1, further comprising rotating an entropy anchor upon detection of staleness and recording a forward link configured to bind a terminal value of a prior epoch to a new initial identity, and rejecting identifiers from an expired epoch except for bridging proofs that open through the forward link.

7. The method of claim 1, further comprising forecasting a near-term successor identity and an acceptance envelope based on cadence statistics and role-transition models; classifying a presented successor as consistent when the presented successor lies within the acceptance envelope; and degrading trust, requesting supplemental proofs, or quarantining when the presented successor falls outside the acceptance envelope.

8. The method of claim 1, further comprising validating, prior to decryption, header-level continuity of the DAH_t against an expected successor and, after decryption, validating payload-level continuity of the DAH_S against a reconstructed trust slope, and rejecting the message without external registry lookup upon failure of validation of either header-level continuity of the DAH_t or payload-level continuity of the DAH_S.

9. The method of claim 1, wherein the symmetric encryption key is derived via a key derivation function keyed by the DAH_R or DDH_R and a context tag, and wherein no asymmetric key exchange is performed.

10. The method of claim 1, wherein, when the sender agent cannot derive a symmetric key from the DAH_R or DDH_R, deriving, by the sender agent, a provisional key from a last trusted recipient anchor and, upon decryption failure, performing, by the sender agent, a fallback including a checkpoint request that yields a bounded proof window or a short challenge-response rekey handshake.

11. The method of claim 10, further including retrying, by the sender agent, decryption within a policy-bounded attempt window.

12. The method of claim 1, further including separating by domain extractor tokens by a fixed public seed and context tag per deployment, and enforcing by validation an acceptance envelope that rejects off-manifold drift without exposing raw local state vectors.

13. The method of claim 1, further including applying, by the recipient, a two-epoch acceptance window for recipient identity, enforcing per-sender rate limits on failed decryptions, and emitting opaque failure codes to prevent oracle leakage.

14. The method of claim 1, further comprising rotating the DAH_t presented in the header at a policy-defined cadence independent of payload semantics.

15. The method of claim 1, wherein deriving the symmetric key includes performing a key derivation function keyed by the DAH_R or DDH_R and a domain-separated context tag, and wherein the derived key expires with a recipient epoch to prevent cross-epoch decryption.

16. A system for agent mutation entanglement, comprising:
a host device configured to compute a dynamic device hash (DDH_t) as a successor of a prior dynamic device hash (DDH_p) under an update rule that incorporates at least one unpredictability contribution and a volatile salt;
a semantic agent configured to execute on the host device and to compute a successor dynamic agent hash (DAH_s) from a prior dynamic agent hash (DAH_p) and a host mutation token derived from the DDH_t and a mutation class associated with the host device;
an entanglement module configured to emit a signed entanglement trace that records DAH_p, DDH_t, the host mutation token, DAH_p, and mutation metadata; and
a validator configured to accept DAH_s only if the entanglement trace opens to DDH_t under policy and DAH_s is a valid successor of DAH_p.

17. The system of claim 16, wherein the host mutation token comprises a cryptographic hash of DDH_t, mutation class, and epoch information, and the entanglement trace includes a signature of the host device.

18. The system of claim 16, further including a monitoring module configured to detect invalid entanglement, cadence anomaly, neighborhood mismatch of extractor outputs, and stale salt, and to degrade trust-score of the semantic agent or quarantine the semantic agent upon detection of invalid entanglement, cadence anomaly, neighborhood mismatch of extractor outputs, or stale salt.

19. The system of claim 16, wherein the semantic agent includes a policy reference to a policy agent that specifies quorum roles, voting weights, and eligibility for mutation validation, and is configured to accept entangled mutations only when quorum roles, voting weights, and eligibility for mutation validation are consistent with the policy.

20. The system of claim 16, further including a message authentication code configured to authenticate the entanglement trace by a value derived from DDH_t under a domain-separated key derivation function in lieu of a digital signature, wherein the key is ephemeral and locally scoped to an epoch of the host device.

21. The system of claim 16, wherein the host device is configured to employ an ephemeral signing keypair minted per epoch and destroyed upon rotation, and including a verifier configured to accept the entanglement trace only when an epoch identifier opens to DDH_t under policy.
